(19) United States
(12) Patent Application Publication
(10) Pub. No.: US 2025/0379880 A1
(43) Pub. Date: Dec. 11, 2025

(54) SYSTEM AND METHOD FOR HIGHLY SECURE REMOTE CONNECTION PATHWAYS BETWEEN ENDPOINT DEVICES AND CLOUD DESKTOPS

(71) Applicant: Workspot, Inc., Campbell, CA (US)

(72) Inventors: Jimmy Chang, Mountain View, CA (US); Amitabh Bhuvangyan Sinha, San Jose, CA (US); Anushree Kunal Pole, Sunnyvale, CA (US); David T. Sulcer, Pacifica, CA (US)

(21) Appl. No.: 19/231,203

(22) Filed: Jun. 6, 2025

Related U.S. Application Data
(60) Provisional application No. 63/656,957, filed on Jun. 6, 2024.

(51) Int. Cl. H04L 9/40

(52) U.S. Cl. CPC H04L 63/1425; H04L 63/0236; H04L 63/1416

(57) ABSTRACT

A system and method for providing a secure pathway between an endpoint device and a virtual desktop executed by one or more servers is disclosed. A client monitoring interface receives connection information from an endpoint device operated by a user during an endpoint device stage of a connection pathway. A gateway monitor receives connection information from a gateway accessible by the endpoint device during a gateway stage of the connection pathway. A virtual desktop monitor receives connection information from the virtual desktop during a desktop stage of the connection pathway. A connection pathway model is created based on previous connection information by the user. A connection orchestrator compares the connection pathway model with the connection information and determines whether to block the connection based on the comparison.

### PRIORITY CLAIM

The present disclosure claims priority to and benefit of U.S. Provisional Application No. 63/656,957 filed on Jun. 6, 2024. The contents of that application are hereby incorporated by reference in their entirety.

### TECHNICAL FIELD

The present disclosure relates generally to Cloud-based virtual application systems. More particularly, aspects of this disclosure relate to establishing secure connection pathways between endpoint devices and cloud desktops.

### BACKGROUND

Computing systems that rely on applications operated by numerous networked computers are ubiquitous. Information technology (IT) service providers thus must effectively manage and maintain very large-scale infrastructures. An example enterprise environment may have many thousands of devices and hundreds of installed software applications to support. The typical enterprise also uses many different types of central data processors, networking devices, operating systems, storage services, data backup solutions, cloud services, and other resources. These resources are often provided by means of cloud computing, which is the on-demand availability of computer system resources, such as data storage and computing power, over the public internet or other networks without direct active management by the user.

Users of networked computers such as in a cloud-based system may typically log into an end point device and are provided a desktop application that displays an interface of applications and data available via the network or cloud. Such desktop applications will be initially accessed when a user logs in, but may remain active to respond to user operation of applications displayed on the desktop interface. While users may activate the desktop application on any computer on the network, most users work from one specific end point device.

Cloud-based remote desktop virtualization solutions have been available for over a decade. These solutions provide virtual desktops to network users with access to public and/or private clouds. In cloud-based remote desktop virtualization offerings, there is typically a capability of associating a remote desktop virtualization template in a particular cloud region with a remote desktop virtualization pool in the same cloud region as part of the general configuration model. This remote desktop virtualization template is customized with the image of the right desktop for a particular remote desktop virtualization use case.

A cloud desktop service system provides cloud applications such as virtual desktops or other remote applications that are allocated from public or private cloud providers. In some cases, the cloud provider and cloud region are already selected. Users of cloud desktops access a computer desktop, or specific desktop application, using a local endpoint device. Each cloud desktop exists within a non-virtual computer known as a host. Some cloud providers may expose the existence of hosts and require that use of a host not be shared between multiple customers, for licensing or other reasons. For that or other reasons a cloud desktop service system may need to manage the allocation of virtual machines onto specific hosts.

A user may connect a display and input device to a cloud desktop, which is a target virtual machine functioning as a remote desktop or remote application host to engage in a remote display session via a certain connection pathway. The term pathway refers to a sequence of hardware and software processing steps that a remote display connection request requires.

One prior art scenario is shown by an example remote connection pathway 10 depicted in FIG. 1A. A user 12 operates an endpoint device 14 that contacts a network 16. Specific client software runs on a specific endpoint device operating system on the specific endpoint device 14, such as a tablet computer, in a specific geophysical location for the user 12 (“jdoe”). The computer network 16 relays the connection request from the endpoint device 14 to a regional cloud 18, that is also known as a “cloud region.” The cloud region 18 may be a data center. A computer network or subnetwork 20 within the cloud region 18 relays the connection request to an intermediary gateway appliance 22. In this example, the gateway appliance 22 operates with a Remote Display Protocol (RDP). The intermediate RDP gateway appliance 22 runs within a different security environment, and runs a specific operating system. A computer network or subnetwork (in this illustration the same network 20 used to reach the RDP gateway) relays the connection request from the RDP gateway appliance 22 to a cloud desktop 24. The cloud desktop 24 accepts the connection request from the RDP gateway appliance 22. The cloud desktop 24 is a virtual machine executed on a server or different servers accessing memory and storage resources.

Furthermore, a cloud desktop service system may orchestrate the creation of an authorized connection pathway and monitor use of the connection pathway in the remote connection pathway 10. FIG. 1B is a diagram of the remote connection pathway 10 with a cloud desktop service system 30. In this example, a first security environment 32 includes the user 12 and the endpoint device 14. A second security environment 34 includes the network 16, cloud region 18, internal network 20 and gateway appliance 22. A third security environment 36 includes the cloud desktop 24. Monitoring components running within the security environments 32, 34, and 36 collect information about the connection pathway. A monitoring or agent software 42 runs within the endpoint environment 32 accessed directly by the user 12 and the endpoint device 14. A monitoring software or agent 44 runs within the RDP gateway environment 34 within the cloud region 18. A monitoring software or agent 46 runs within the cloud desktop environment 36 within the cloud region 18. The cloud desktop service system 30, sometimes implemented as a cloud desktop service control plane, receives information from each processing step. This information is stored into a repository to enable monitoring and control of the connection activities.

However, at each processing step along the connection pathway 10, attacks are possible if an unauthorized user can successfully impersonate the user. Attacks may also be made by other means. For example, malware may be installed in some of the software responsible for the processing step that can capture a security token and enable a “replay attack” to impersonate the valid session but using a different network. FIG. 1C shows illustrates an attack that exploits some vulnerability at the endpoint processing step in the connection pathway 10. In this example, an unauthorized user 50 impersonates the user 12 through another network 52 and thus accesses the endpoint device 14. FIG. 1D shows another type of attack that exploits the gateway processing step. In this example, the unauthorized user 50 accesses the network 52 to access the regional cloud 18. Similarly, as shown in FIG. 1E, there could be an exploit of the cloud desktop 24 by the unauthorized user 50 that has penetrated the network 20 of the operator of the regional cloud 18.

There are a number of tools available to enhance the security of the specific environments in which these separate components operate and the networks that connect the components. The prior art solutions for enhancing security include Extended Detection and Response (EDR) Solutions for preventing attacks to cloud networks; Security Information and Event Management (SIEM) that gather and manage a stream of information about complex systems; Identity Providers (IdP)/Single Sign On (SSO) Solutions that authenticate users; Insider Risk Management (IRM) Solutions that identify threats from trusted users; and IT Service Management (ITSM) Solutions that manage infrastructure. When properly deployed, each individual processing step of the connection pathway 10 can be made more secure. Also, with significant effort, such prior art tools can be combined into a greater solution ecosystem. However, because each tool does not cumulatively analyze each processing step along the entire connection pathway, an attacker needs only to find a single vulnerability in order to gain unauthorized access.

Thus, there is a need for a method that comprehensively increases security along an entire connection pathway. There is a further need for a mechanism to compare connection pathway attempts to information collected by the cloud desktop service system about valid connection pathways. There is another need for a system that can leverage connection data to establish individual user models to provide secure connection pathways.

### SUMMARY

One disclosed example is a system providing a secure pathway between an endpoint device and a virtual desktop executed by one or more servers. The system includes a client monitor that receives connection information from an endpoint device operated by a user during an endpoint device stage of a connection pathway. The system includes a gateway monitor receiving connection information from a gateway accessible by the endpoint device during a gateway stage of the connection pathway. The system includes a virtual desktop monitor receiving connection information from the virtual desktop during a desktop stage of the connection pathway. A real-time connection database stores the connection information from the client monitoring interface, gateway monitor and virtual desktop monitor. A models database stores a connection pathway model with connection information from previous connections made by an endpoint device operated by the user. A connection orchestrator compares the connection pathway model with the connection information received by at least one of the client monitor, the gateway monitor, or the virtual desktop monitor and determines whether to block the connection based on the comparison.

In another implementation of the disclosed example system, the models database includes a plurality of connection pathway models, each associated with the user. The connection orchestrator compares all of the connection pathway models with the connection information. In another implementation, the system includes a client connection supervisor coupled to the endpoint device; a gateway connection supervisor coupled to the gateway; and a desktop connection supervisor coupled to the virtual desktop. A control plane is coupled to the client connection supervisor, gateway connection supervisor and desktop connection supervisor. The control plane includes the connection analyzer and is operable to control one of the client connection supervisor, gateway connection supervisor and desktop connection supervisor to block the connection. In another implementation, the connection orchestrator is operable to flag the connection based on the comparison. In another implementation, the connection orchestrator is operable to perform the comparison at each of the stages of the connection pathway. In another implementation, the example system includes a connection analyzer that accesses a model template to create the connection pathway model with the connection information from previous connections made by an endpoint device operated by the user. In another implementation, the example system includes another monitor and another supervisor. The connection pathway includes another stage and the another monitor collects information from the another stage. The another supervisor blocks connection at the another stage. In another implementation, the connection information collected by the endpoint device monitor includes at least one of device operating system, device location, network type, IP address, gateway, a unique device identifier, and a unique network identifier. In another implementation, the connection information collected by the gateway monitor includes at least one of a gateway name, a gateway protocol, ports use, network tracking, a network latency, and an authentication method. In another implementation, the connection information collected by the Cloud desktop monitor includes at least one of a name of the gateway, a regional data center, and a network ID.

Another disclosed example is a method for providing a secure pathway for connecting an endpoint device to a virtual desktop via a gateway and Cloud based region. Connection information from an endpoint device operated by a user during an endpoint device stage of a connection pathway is received. Connection information from a gateway accessible by the endpoint device during a gateway stage of the connection pathway is received. Connection information from the virtual desktop during a desktop stage of the connection pathway is received. The connection information from the client monitoring interface, gateway monitor and virtual desktop monitor is stored in a real-time connection database. A connection pathway model with connection information from previous connections made by an endpoint device operated by the user is compared with the connection information. It is determined whether to block the connection based on the comparison.

In another implementation of the disclosed example method, the connection pathway model is one of a plurality of connection pathway models, each associated with the user. The example method further includes comparing all of the connection pathway models with the connection information. In another implementation, a client connection supervisor is coupled to the endpoint device; a gateway connection supervisor is coupled to the gateway; and a desktop connection supervisor coupled to the virtual desktop. A control plane is coupled to the client connection supervisor, gateway connection supervisor and desktop connection supervisor. The control plane is operable to control one of the client connection supervisor, gateway connection supervisor and desktop connection supervisor to block the connection. In another implementation, the example method includes flagging the connection based on the comparison. In another implementation, the comparison is performed at each of the stages of the connection pathway. In another implementation, the example method includes accessing a model template to create the connection pathway model with the connection information from previous connections made by an endpoint device operated by the user. In another implementation, the example method includes collecting information from another stage of the connection pathway. A supervisor blocks connection at the another stage based on the comparison. In another implementation, the connection information received from the endpoint device includes at least one of device operating system, device location, network type, IP address, gateway, a unique device identifier, and a unique network identifier. In another implementation, the connection information received from the gateway includes at least one of a gateway name, a gateway protocol, ports use, network tracking, a network latency, and an authentication method. In another implementation, the connection information received from the Cloud desktop includes at least one of a name of the gateway, a regional data center, and a network ID.

Another disclosed example is a non-transitory computer-readable medium having machine-readable instructions stored thereon, which when executed by a processor, cause the processor to receive connection information from an endpoint device operated by a user during an endpoint device stage of a connection pathway. The instructions cause the processor to receive connection information from a gateway accessible by the endpoint device during a gateway stage of the connection pathway. The instructions cause the processor to receive connection information from the virtual desktop during a desktop stage of the connection pathway. The instructions cause the processor to store the connection information from the client monitoring interface, gateway monitor and virtual desktop monitor in a real-time connection database. The instructions cause the processor to compare a connection pathway model with connection information from previous connections made by an endpoint device operated by the user with the connection information; and determine whether to block the connection based on the comparison.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1A is a diagram showing a prior art pathway for Cloud based computing;

FIG. 1B is a diagram showing a prior art pathway with security environments and

a service system control plane;

FIG. 1C is a diagram showing a prior art pathway under attack from

FIG. 1D is a diagram showing a prior art pathway under attack from

FIG. 1E is a diagram showing a prior art pathway under attack from

FIG. 2 is a diagram of the working principles of the example system in a traveler analogy;

FIG. 3 an example architecture of a system for providing secure connection pathways to a Cloud desktop;

FIG. 4 is a process diagram of exchanging security information with the example proxy for providing a remote application in the system in FIG. 2;

FIG. 5A is a diagram of the configuration process for creating connection pathway models for a user;

FIG. 5B is a chart showing a connection pathway model for an individual user;

FIG. 6 is an example model template for creating connection pathway models;

FIG. 7 is a diagram of the real-time comparison process to determine actions for a requested connection;

FIG. 8A is an example of an individual user connection pathway model;

FIG. 8B is an example of another connection pathway model for the same user in FIG. 8A;

FIG. 8C is a table showing information collected in real-time from the endpoint device environment for comparison to the example connection pathway model;

FIG. 8D is a table showing information collected in real-time from the gateway environment and the Cloud desktop environment for comparison to the example connection pathway model;

FIG. 8E is a table showing information that is partially collected in real-time that is used for comparison to the example connection pathway model;

FIG. 9A is a diagram showing information collected from the monitor in the endpoint device environment;

FIG. 9B is a diagram showing information collected from the monitor in the gateway environment;

FIG. 9C is a diagram showing information collected from the monitor in the Cloud desktop environment;

FIG. 9D is a diagram showing information collected from a monitor in the regional data center environment; and

FIGS. 10 and 11 illustrate exemplary computer systems in accordance with various examples of the present disclosure.

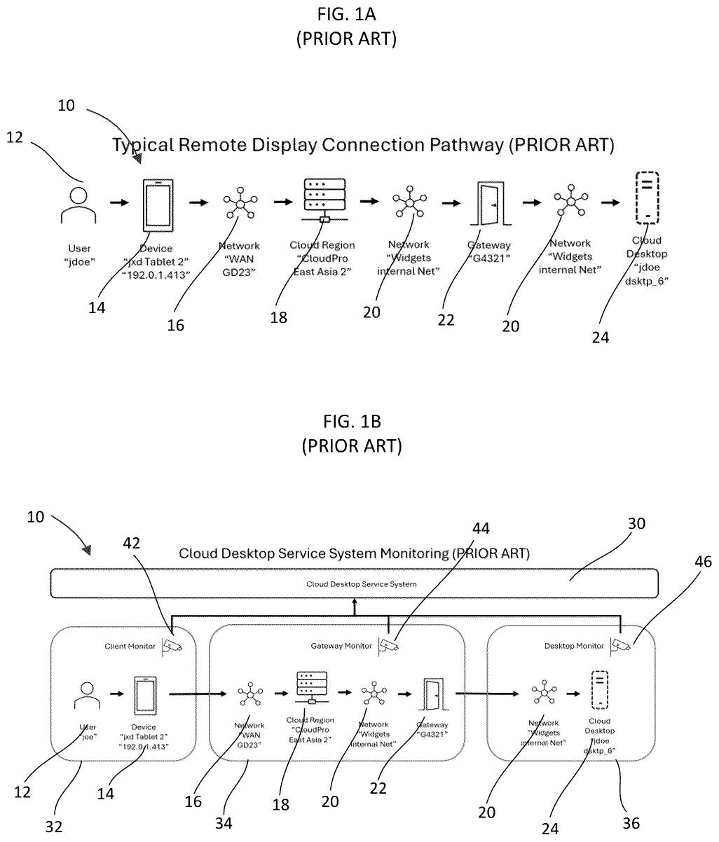

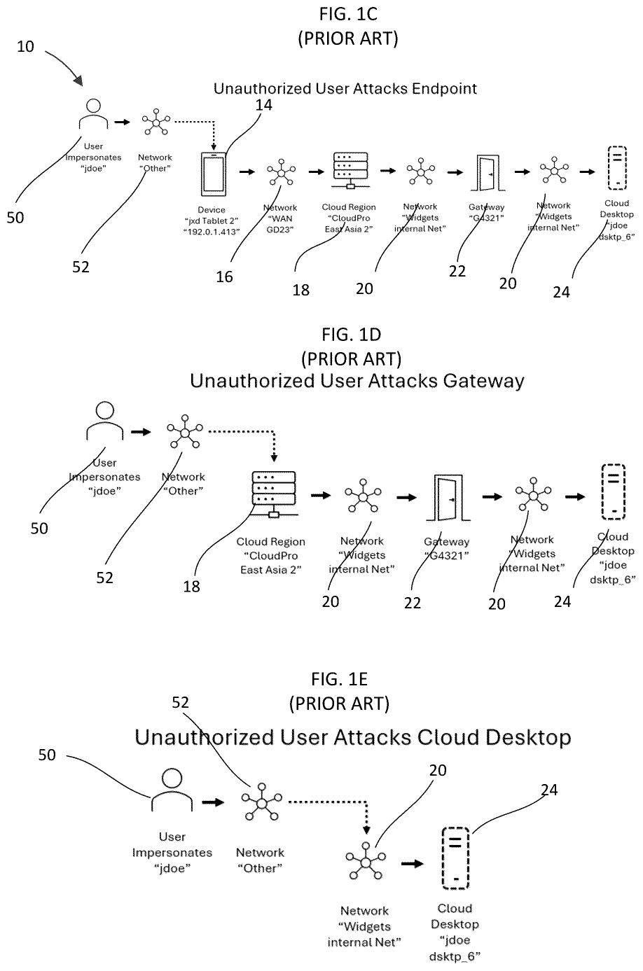

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure relates to a method and system to reduce the possibility of attack by cumulatively analyzing a connection pathway between an endpoint device and a cloud desktop to establish a remote display session, in near-real time. The analysis is based on comparing the connection pathway with known valid connection pathways for that user to ensure a secure connection pathways.

Some terms used in this disclosure to describe elements of one embodiment of a solution are as follows.

Cloud Desktop—A target virtual machine functioning as a remote desktop or remote application host.

Client—The environment in which the end user directly interacts with a Cloud Desktop using a Connection.

Connection—A specific remote display and input session between a user and a cloud desktop.

Connection Pathway—The actual sequence of components implementing processing steps that participate in establishing and maintaining a Connection in a specific instance.

Connection Pathway Template—A description of the types and other information about components that may be used to validate an authorized Connection Pathway. This may include a mapping that allows relationships of processing steps to known configuration objects such as users, gateways, regions, and cloud desktops.

Connection Pathway Policies—Configurations that will be used during connection orchestration to control the behavior of the system. For example, a policy could map certain conditions (such as a posture check failure) to certain actions (such as a connection termination action). It might apply to a single user, or a group of users, or groups of other components used in the Connection Pathway.

Connection Pathway Configurable Logic—Behavioral logic that could be expressed as code, heuristic rules, or some other way, to have fine-grain control over analysis or orchestration and possibly allow customization of the system to deal with a wide-variety of scenarios.

Connection Pathway Model—Specific components that have been discovered to be used by specific users and are expected to be used again.

Connection Analyzer—Software that can understand Pathway Information to detect usage patterns

Connection Orchestrator—Software that can determine actions that may need to be taken by components in a Connection Pathway.

Connection Supervisor—Software running within the environment of a component in a Connection Pathway that can respond to orchestration actions by the Connection Orchestrator.

Cumulative Pathway Information—Specific facts about the user or environment of components in a Connection Pathway that may be relevant to analysis and/or orchestration of it. The information is typically collected in real-time or “near real time” but may also be used for period or ad-hoc bulk analysis operations. It is cumulative because at each processing step in the pathway, additional information from the associated monitor can be added to the information already collected for the pathway.

Context—Any metadata used by an associated connection pathway when a user tries to establish a session with the associated Connection Pathway.

Gateway—one example of an intermediate component in a Connection Pathway, that helps create secure Remote Display Protocol (RDP) or other protocol connections.

Cloud Region—A data center hosting cloud desktops, and possibly other components to enable access to them, including gateways and network infrastructure. For the purposes of this disclosure the term includes those offered by public cloud providers, or private data centers that may be located “on premise” and/or considered to be a “private cloud.”

Cloud Desktop—Any use of a virtual machine to create a remote application experience for a user, including a dedicated operating system session including desktop software, or a shared environment for specific remote applications.

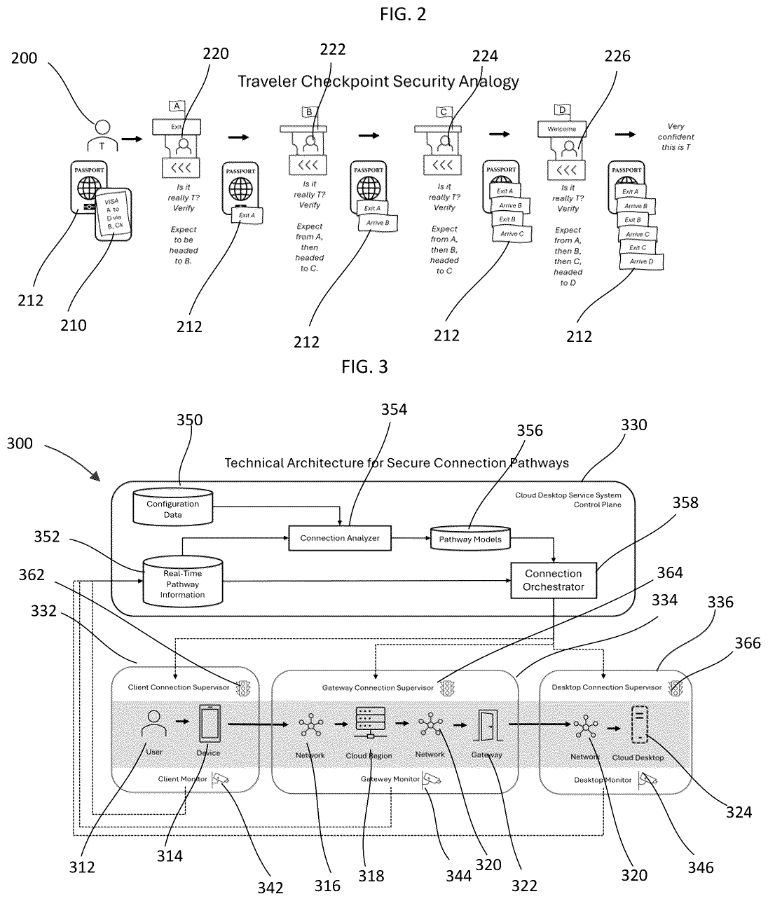

FIG. 2 shows a loose analogy of the principles of the example method to ensure a secure pathway. FIG. 2 shows a world traveler authorized to enter a highly secure destination. In this scenario, transit through certain nations may be considered unusual and/or suspicious, while other transits through known pathways decrease the perceived risk. Thus, an example technique to validate the visit to the high secured destination is to examine the routes taken by the traveler to get there (represented by a transit visa 210) to see if the traveler has followed an expected pathway. For example, an agent at the border control of the destination might examine recent arrival and exit stamps in a passport 212 that reflect visits to example destinations through respective checkpoint 220, 222, 224 and 226. For even stronger security, each checkpoint 220, 222, 224 and 226 along the route could re-verify the identity of the traveler 200 and cumulative route.

In this analogous example the traveler 200 begins the journey from the destination associated with the checkpoint 220 with a passport 212 that establishes identity and the transit visa 210 that establishes the parameters of the journey. As the journey begins, the passport 212 is stamped with a date by the checkpoint 220 to record an exit from the first destination. When the traveler arrives at the checkpoint 222 in the second destination, the identity of the traveler can be checked again by their documents, as well as with a central authority. Thus, it is known that the traveler is coming from the first destination and going to the third destination. The interaction with the checkpoint 222 is recorded as “Exit” and “Entry” date stamps in the passport 212.

Similarly, when the traveler arrives at the checkpoint 222 in the third destination, the identity of the traveler can be checked again. It is known that the traveler is coming from the first destination, then the second destination, and going to the fourth destination. The interaction with the checkpoint 224 is recorded as “Exit” and “Entry” date stamps in the passport 212.

When the traveler arrives at the fourth destination, the identity of the traveler can be checked a final time. It is known that the traveler came from the first destination, then the second destination, then the third destination, and finally to the fourth destination. An authority can be very confident that the traveler is indeed the identified traveler.

The analogy applies to certain elements in the context of the disclosed example method to help explain their function. Each “checkpoint” 220, 222, 224, and 226 is analogous to a step in a connection pathway that is part of establishing the session, and that is in communication with a cloud desktop service system control plane. The “passport” 210 is analogous to the context of a particular user attempting to create a remote display session via a particular connection pathway instance. The “transit visa” 210 is analogous to a known connection pathway model that is allowed and/or expected by a legitimate user. The “Exit” and “Entry” stamps in the passport 210 are analogous to collection of data about the elements of the connection path that are passed through.

The border control function of the last destination, as it observes and manages all the checkpoints 220, 222, 224 and 226, is analogous to a connection orchestrator combined with connection supervisors at each checkpoint.

FIG. 3 shows a secure connection pathway architecture 300 that allows a user 312 through an endpoint device 314 to access a virtual or cloud desktop. Specific client software runs on a specific endpoint device operating system on the specific endpoint device 314, such as a tablet computer, in a specific geophysical location for the user 312. A computer network 316 relays the connection request from the endpoint device 314 to a regional cloud 318, that is a data center or data centers also known as a “cloud region.” A computer network or subnetwork 320 within the cloud region 318 relays the connection request to an intermediary gateway appliance 322. In this example the gateway appliance 322 operates according to the Remote Display Protocol (RDP), but other connection protocols may be used. The example intermediate RDP gateway appliance 322 runs within a different security environment, and runs a specific operating system. A computer network or subnetwork (in this illustration the same network 320 used to reach the RDP gateway) relays the connection request from the RDP gateway appliance 322 to a cloud desktop 324. The cloud desktop 324 accepts the connection request from the RDP gateway appliance 322. The cloud desktop 324 is a virtual machine executed on a server or different servers accessing memory and storage resources.

Endpoint devices such as the endpoint device 314 may be any device having computing and network functionality, such as a laptop computer, desktop computer, smartphone, or tablet. The endpoint devices execute a desktop client to access remote applications such as the cloud desktop. The desktop client application authenticates user access to the applications provided by the Cloud desktop service system in conjunction with the Cloud provider data center that constitutes the cloud region 318. An endpoint device can be a conventional computer system executing, for example, a Microsoft™ Windows™-compatible operating system (OS), Apple™ OS X, and/or a Linux distribution. An endpoint device can also be a device having computer functionality, such as a personal digital assistant (PDA), mobile telephone, tablet, video game system, etc.

The Cloud provider system includes a gateway host executed by the gateway 322, managed cloud desktop virtual machines, a cloud provider API, and other resources. The Cloud desktop service system includes a desktop management service, a user/group manager, and a monitoring service that communicates with different monitors. A customer of the Cloud provider system relies on the Cloud provider system to provide virtual machine resources for executing applications such as the virtual or Cloud desktop 324 that are managed by the desktop service system.

Common global pools of Cloud desktops may be available to serve the users, whereby each global pool is based on a common desktop template. There can be multiple global pools based on which groups users belong to and their job requirements. For example, the desktop service system may manage different pools for a customer such as a developer desktop pool, an engineering workstation pool, or a call center application pool. The Cloud desktops each include configuration and definitions of resources necessary to offer the Cloud desktop to the end point device running the client application. There can be multiple logical pools based on which groups users belong to and their job requirements. The Cloud desktops each include configuration and definitions of resources necessary to offer the cloud desktop. The Cloud desktops in a particular pool may each be supported by different cloud providers based on the requirement of the desktop pool.

Definitions and configurations for infrastructure and desktop service resources, including gateways, desktop templates, and others that are applied to cloud regions are managed by the Cloud desktop service system. The Cloud provider system implements the resources, including virtual cloud Desktops, infrastructure, and other virtual resources, all of which are virtual machines or other virtual resources hosted in a public or private Cloud.

The desktop service control plane 330 includes a desktop management service, a user/group manager, and the monitoring service. The service control plane 330 can manage the entire lifecycle of a Cloud desktop service implementation, from creating and managing the required Cloud desktops, to monitoring and analyzing the stream of operational data collected, enforcing security policies, and optimizing the experience for IT administrators and Cloud desktop users. For example, the desktop service control plane 330 may register a set of a virtual networks, virtual storage resources, and more. Within a virtual network, the control plane may further register and coordinate the use of gateways, enterprise connectors, desktop templates, connection brokers, and more.

The desktop client application running on an endpoint device allows a user to access a virtual desktop that is managed by the desktop management service of the desktop service system, and provided by virtual machines running on the cloud provider system. As explained above, the example desktop client is software executed by device hardware available in the local environment of a desktop user to remotely access a managed Cloud desktop using a remote desktop protocol. The desktop client communicates with the desktop service control plane 330 of the desktop service system to monitor latency, response-time, and other metrics to measure quality of user experience and also supports a remote display protocol in order for users to connect to a Cloud desktop application run by the Cloud provider system.

The desktop client application accesses the cloud provider system via the gateway 322. The virtual Cloud desktop application is provided by the virtual machine. In this example, the monitoring agents 342, 344 and 346 are in communication with the monitoring service of the Cloud desktop service system 330. The gateway appliance 322 may be present to provide secure public or internal limited access to the managed Cloud desktops, that may be deployed on a virtual machine of its own. The gateway agent software application may be deployed on the virtual machine of the gateway by the Cloud desktop service system control plane 330. The gateway agent enables the Cloud desktop service system control plane 330 to assist in configuration and operations management of the gateway appliance 322.

Cloud provider systems such as the Cloud provider system include a cluster of host servers that host the various applications as well as appropriate storage capabilities, such as virtual disks, memory, and network devices. Thus, the Cloud provider system typically comprises IT infrastructure that is managed by IT personnel. The IT infrastructure may include servers, network infrastructure, memory devices, software including operating systems, and so on. If there is an issue related to an application reported by a user, the IT personnel can check the health of the infrastructure used by the application. The Cloud provider system may include a firewall to control access to the applications hosted by the Cloud provider system as part of the security environment. The firewall enables computing devices behind the firewall to access the applications hosted by the Cloud provider system, but prevents computing devices outside the firewall from directly accessing the applications. The firewall may allow devices outside the firewall to access the applications within the firewall using a virtual private network (VPN).

The monitoring service of the desktop service system makes both routine and error events available to administrators and can analyze operational performance and reliability. The monitoring service interacts with monitoring components such as the monitors 342, 344, and 346, to obtain operational data relating to the desktop, and operational data generated by the control plane itself. The monitoring service may store all such operational data for later analysis.

The desktop management service interacts with the one or more managed virtual machines (MVMs). In this example, the desktop management service manages resources for providing instantiated Cloud desktops to the users in the logical pools, orchestrating the lifecycle of a logical desktop.

The Cloud service provider operational application programming interface (API) presents services provided by the Cloud service provider that also participate in the management of the virtual machine. This can be utilized by the desktop service control plane 330 to perform operations like provisioning or de-provisioning the virtual machine.

In this example, a cloud desktop service system control plane 330 may orchestrate the creation of an authorized connection pathway and monitor use of the connection pathway. In this example, an endpoint device security environment 332 includes the user 312 and the endpoint device 314. A gateway security environment 334 includes the network 316, cloud region 318, internal network 320 and gateway appliance 322. A cloud desktop security environment 336 includes the Cloud desktop 324. The environments 332, 334, and 336 are termed stages of the connection pathway. Each stage 332, 334, and 336 must be followed for the endpoint device 314 to access the Cloud desktop 324. Monitoring components 342, 344, and 346 running within the security environments 332, 334, and 336 collect information about the connection pathway. The monitoring or agent software 342 runs within the endpoint environment 332 accessed directly by the user 312 and the endpoint device 314. The monitoring software or agent 344 runs within the RDP gateway environment 334 within the cloud region 318. The monitoring software or agent 346 runs within the cloud desktop environment 336 within the cloud region 318.

In this example, the cloud desktop service system control plane 330 includes a configuration database 350, a real-time pathway information database 352, a connection analyzer 354, pathway models 356 (stored in a models database) and a connection orchestrator 358. Configuration data is stored about valid users, valid clients, valid gateways, valid desktops, and the like in the configuration database 350. Real-time pathway information is collected from the monitors 342, 344, and 346 installed on various pathway processing components. The example connection analyzer 354 uses this information to determine if connections are valid based on comparisons with the models 356. The connection pathway models 356 of valid connection pathways are stored in the models database for future connection pathway instances. The connection orchestrator 358 compares current connection pathway information with the known models 356 to validate that the current connection pathway is valid, at each processing step. If not valid, the connection orchestrator 358 can take actions such as increasing the risk assessment of the connection attempt or blocking the attempt.

Along the connection pathway itself (shown as a 3-part pathway in this case, including client, gateway, and virtual desktop), each security environment 332, 334, and 336 representing a connection stage includes a corresponding monitor 342, 344, and 346 that collects security and other information from the monitored environment and sends it to the pathway information database 352. Each of the environments 332, 334, and 336 include a supervisor 362, 364, and 366. The example supervisors can take actions including blocking the connection attempt.

The architecture 300 is illustrative of one example implementation using the centralized control plane 330 to perform analysis and orchestration and allocates monitoring and supervision to the components in the connection pathway. These functions may be performed by other components in other architectures.

For example, in an alternative design, instead of a centralized control plane providing the analysis and orchestration functions, cumulative pathway information could be stored in a decentralized fashion, and/or be incrementally staged to connection pathway components such as the endpoint device 314, gateway appliance 322, or virtual desktop 326. Some or all of this processing could be performed locally by the pathway components themselves. The example design thus might be adopted to optimize run-time performance by reducing communication with the control plane 330.

Another example could employ other communication paths between the components that would vary according to the chosen design. For example, collecting and/or forwarding monitoring data might be transmitted using a “dynamic virtual channel” that may be supported in the RPC protocol between clients and desktops.

In order to successfully compare current connection pathways with known connection pathway models for each user, the pathway models 356 must be created and curated. There are many possible methods to create and curate the pathway models. One approach is to employ a combination of curated connection model templates and policies, with analysis of collected run-time data as connections occur to develop the model. Thus, the system can train itself using repeated valid accesses by creating individual connection pathway models for each valid user based on templates of expected connection pathway patterns. Once trained, the system can determine necessary actions affecting the connection and implement those actions.

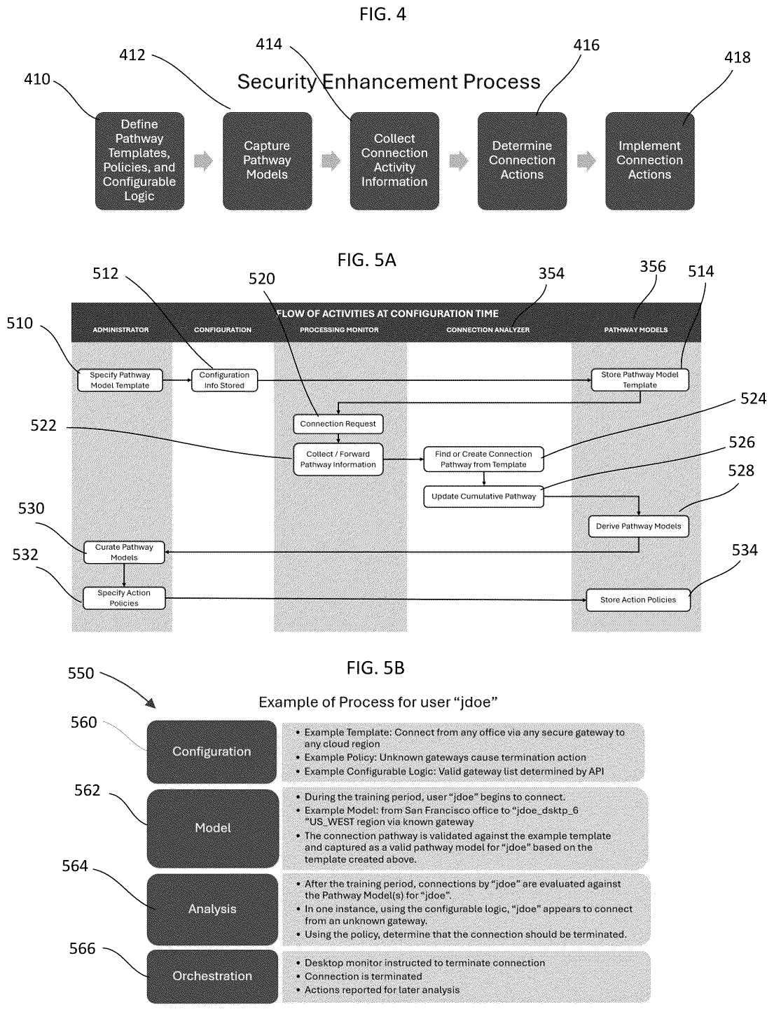

FIG. 4 shows the overall process of creating a secure pathway policy at a high level. Examples follow this summary. First, configuration objects such as pathway templates, polices and configurable logic are defined (410). Defining configuration objects allows administrators to create a skeleton of an allowed pathway based on their understanding of the configuration of the system. The pathway templates are created by identifying the processing steps for a connection. The templates may include a mapping that allows relationships of processing steps to known configuration objects such as users, gateways, regions, and cloud desktops. The policies are common configurations that will be used during connection orchestration to control the behavior of the system. For example, a policy could map certain conditions (such as a posture check failure) to certain actions (such as a connection termination action). The configurable logic represents behavioral logic that could be expressed as code, heuristic rules, or some other way, to have fine-grain control over analysis or orchestration and possibly allow customization of the system to deal with a wide-variety of scenarios.

Pathway models are then captured (412). This may be considered a training phase for a new connection pathway for a user once they begin to connect to a virtual desktop. Once trained, the system will connect information from each monitored processing step of the connection pathway (414). The system then determines connection actions (416). The current connection activity information may be compared with connection pathway models, and policies and/or other configurable logic can determine if or when actions should be implemented. The logic here could be implemented in many forms, including: configurable logic described above; procedural interpreted or compiled code, including scripting languages; heuristic rules; and external analysis engines including machine learning/artificial intelligence. Logic can determine actions to be taken including blocking the connection if the endpoint device type and OS don't match, blocking the connection if the user is bypassing gateways or accessing gateways not in the connection pathway model associated with the user, alerting if the user is on a network that is not in the connection pathway model, and enabling more restrictive security policies such as disabling printing and file sharing.

Connection actions are then implemented based on the analysis (418). The connection actions may include actions such as providing an alert; setting a flag to the system to collect more information; and blocking this connection attempt, user, or any specific processing step.

FIG. 5A is a diagram showing an example flow of activities between solution elements for definition of templates and capture of pathway models in the configuration and training stage. The activities are broken down between an administrator, the configuration process performed by the desktop system control plane 330, the processing monitor such as the monitors 342, 344, and 346 in FIG. 3, the connection analyzer 354 and the pathway models 356 in FIG. 3. The administrator first specifies the pathway model template (510). The configuration information is stored (512). The pathway model template is stored in the pathway models 356 (514). Through these steps, during system configuration time, administrators can create templates that describe the processing stages, utilizing and updating configuration information and storing the templates for use at runtime. For example, a template might indicate that there are clients, gateways, desktops, and network characteristics that are shared by multiple users, and specify the types of connection pathway information that are relevant.

When run-time connection requests begin (520) the pathway information of each processing stage is collected from the monitors at each stage (522). The connection requests may initially be part of supervised training activities. The connection analyzer 354 finds or creates the connection pathway from the template (524). The connection analyzer 354 merges the actual run-time pathway information details with the configured templates (526). This effectively “fills in” the details of the values of a connection pathway model for a particular user. Pathway models for the user are thus derived when the information is added to the template (528). For example, at this point a user may have two or more connection pathway models created for them. Thus, a user may have one connection pathway model for an office connection through a particular gateway, and another connection pathway model for a remote WAN connection through a different gateway.

The administrator then may curate the pathway models (530). Curation of the configuration objects simply means even though some objects may be generated automatically by the system such as connection pathway models, they can still be managed by administrators. The management may curate the pathway models by actions such as: manually revising them, approving them, reporting on them, and observing how they are actually used by the system. The action policies are then specified (532). Specifying policies depends on the understanding of the system requirements and security policies of the organization using the system. Policies may include blocking a connection (736), flagging a connection (732), which may include other actions such as, requiring additional verification of credentials, issuing an alert based on the analysis, and routing connection to another path based on risk, and establishing a connection (738). The action policies are then stored in the pathway models (534).

FIG. 5B is a chart 550 showing how this process might be used to ensure a secure pathway for a specific user. The chart 550 includes a configuration 560, a model 562, an analysis phase 564 and an orchestration 566. In this example, the configuration 560 specific to the user includes an example template that allows connection from any office via any secure gateway to any Cloud region. The example individual policy is that an unknown gateway causes a termination action. The example configurable logic includes a valid gateway list determined by API.

The example model 562 is based on the user beginning to connect during a training period. In this example, the model is a connection from the San Francisco office to specific region via a known gateway. The model includes that the connection pathway is validated against the example template and captured as a valid pathway model for the individual based on the example template.

The example analysis 564 includes connections by the example user are evaluated against the pathway model for the user. In one instance, using the configurable logic, the individual appears to connect from an unknown gateway. Using the policy, the connection is terminated.

The example orchestration 566 includes instructing the desktop monitor to terminate the connection. The connection is terminated and actions are reported for later analysis.

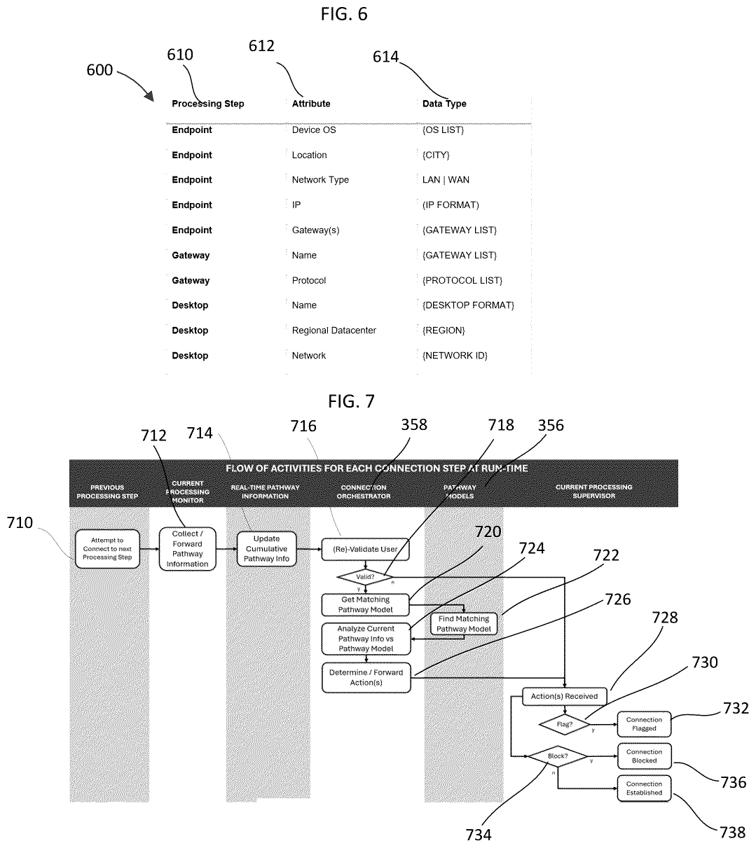

FIG. 6 shows an example of a connection pathway model template 600 of different attributes that an administrator can specify for each step in the connection pathway. The template 600 includes a column 610 of processing steps in the different security environments 332, 334, and 336 in FIG. 3, a column 612 of corresponding attributes, and a column 614 lists the corresponding data types to each attribute. The data types in the column 614 are assigned user specific data based on a real-time connection to create a specific pathway model is provided for a user. In this example, the attributes for the endpoint device processing step includes the device OS, the location, network type, IP address, the gateways, unique device identifiers, and unique network identifiers. The attributes for the gateway step include the gateway name, the gateway protocol, ports use, network tracking, network latency, and authentication methods. The attributes for the virtual desktop step include the name of the gateway, the regional data center, and the network ID. Other optional attributes may include authentication method, ports used, device unique identifiers, network tracing and unique identifiers, and network latency.

FIG. 7 shows a flow process of activities performed during run-time of the virtual desktop system. The columns include actions performed by the previous processing supervisor, the processing monitor such as one of the monitors 342, 344, and 346 in FIG. 3, the real-time pathway information collected, the connection orchestrator 358, the pathway models 356, and the current processing supervisor. The previous processing supervisor and current processing supervisors are selected from the supervisors 362, 364, and 366 in FIG. 3 and depend on the progression through the connection pathway. Run-time use is validated to enhance security using the connection pathway models 356 created in the activity flow described in FIG. 5. As noted above, whenever another step in the connection pathway in FIG. 3 is processed, there is information collected by the corresponding monitor 342, 344, and 346, and this information is used to evaluate whether the connection pathway should continue, be blocked, or if other actions take place.

The process begins with an attempt to connect to components in the pathway such as the gateway or Cloud desktop (710). The current process monitor then collects and forwards pathway information (712). The information collected will vary along the connection pathway. For example, the client application on the endpoint device 314 can provide the IP address, posture check information, geo location, and other data. The gateway and desktop stages have different information that is collected by the corresponding monitors 344 and 346. The real time pathway information is updated (714). At each processing step, the pathway information includes the information gathered from all previous steps.

The connection orchestrator 358 re-validates the user (716). The cumulative pathway information may allow the connection orchestrator 358, using coded routines, a rule-based system, or any other logical method, to immediately determine that the user is not valid. For example, the posture check information received may indicate a problem with the user. Examples of bad posture check include the OS of an endpoint device does not have the latest security updates, or a network location does not meet the minimum requirement to validate the user. Actions can immediately be returned to the supervisor of the processing stage.

The connection orchestrator 358 determines whether the user is valid (718). If the user is valid, the connection orchestrator 358 gets the matching pathway model (720). The matching pathway model is obtained from the pathway models 356 (722). The connection pathway models 356 show how expected pathways should look in terms of the source and destination of each intermediary connection, the expected location for the user, the expected network for the user, the expected gateway used by the user, or any other normative information for comparative purposes. The process of finding matches may also allow the use of inexact or “fuzzy” specifications in the model, such as allowing a range or known subset of possible values for each part of the model. For example, the OS of an end point device is on n-1 version or within a time frame, a network within an IP address range used by an authorized location, or security software from various vendors that meet the configured requirements.

A matching connection pathway may not exist or may not be found. If a matching connection pathway is not found, possible responses by the connection orchestrator 358 could include: disallowing such connection attempts after the training period has ended based on specified action policies; treating the connection attempt as a candidate new connection pathway and submit it for validation/approval; or automatically create a new connection pathway model and flag it for review.

A user may have two or more connection pathway models associated with them. For example, one pathway model might be associated with a user accessing their desktop while in the corporate office over a LAN.

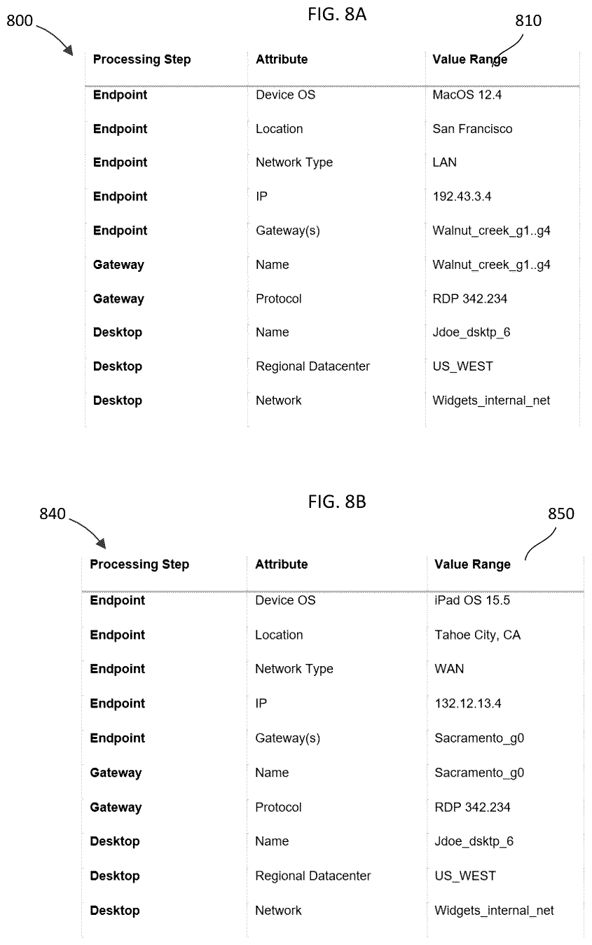

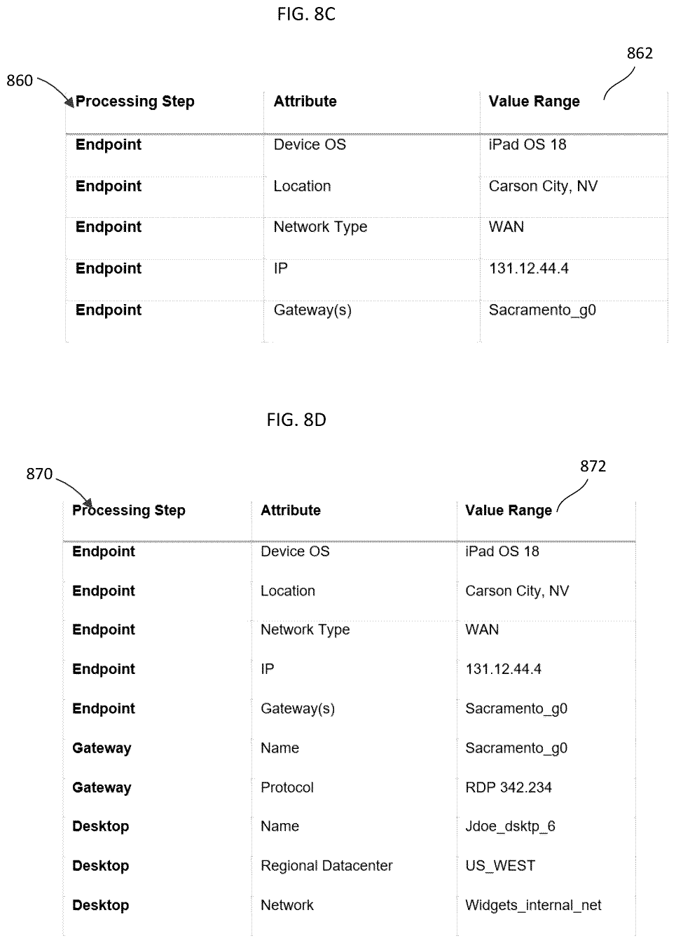

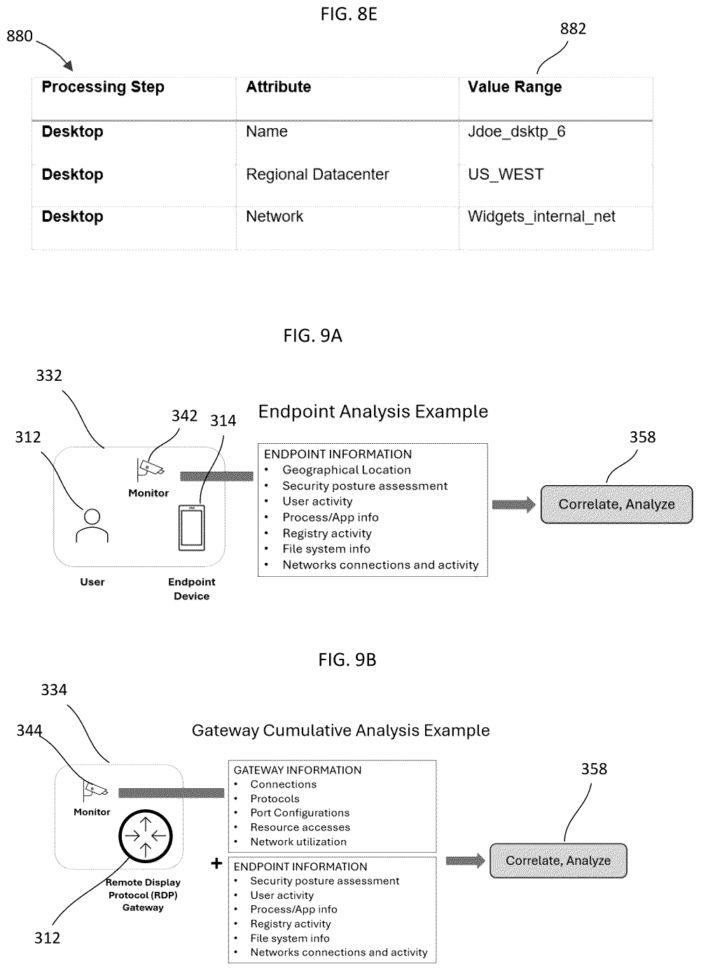

FIG. 8A is a simplistic example of a connection pathway model 800 that is created from the template 600 in FIG. 6. In this example, the model 800 has specific user data such as the device OS, location, IP address for the endpoint device, gateway name, and RDP for the gateway, and user name, data center name, and network name for desktop filled in a value range column 810. The information in the model 800 is created from previous connections made by the user.

FIG. 8B is another example connection pathway model 840 for the same user that is also created from the template 600 in FIG. 6. The pathway model 840 illustrates a second connection pathway model for the user, in this case for use while using a WAN from a tablet in a distant location. In this example, the model 840 has specific user data such as the device OS, location, IP address for the endpoint device, gateway name, and RDP for the gateway, and user name, data center name, and network name for desktop filled in a value range column 850. As may be seen, the specific user data in the column 862 differ from certain user data in the column 810 in FIG. 8A.

Returning to FIG. 7, the connection orchestrator 358 analyzes the current pathway versus the matching connection pathway model (724). The orchestrator 358 can compare elements of the current pathway collected by the monitors with all known connection pathway models to determine if there is a discrepancy. Based on the analysis, the orchestrator 358 may determine actions in relation to the current pathway (726).

The example connection pathway models in FIGS. 8A-8B are used at the different connection stages in FIG. 3. For example when the endpoint processing stage is reached, the current cumulative pathway information relating to the endpoint device 314 may be data represented in a table 860 in FIG. 8C. The table 860 includes the attribute data collected in the endpoint device processing stage in a column 862. In this example, there is no gateway or desktop stage pathway information available yet. However, at the endpoint device stage, the orchestrator 358 can already determine that the device OS, geo location, and IP address values in the column 862 of the table 860 do not match the corresponding data found in either of the connection pathway models 800 or 840 for the example user. However, using custom code, external logic engines, heuristic rules, “fuzzy logic”, or some other method, the orchestrator 358 may determine that this connection may be valid because the values are not expected to contain exact matches in all cases. Therefore, the orchestrator 358 could determine that the connection should be flagged for attention and not blocked. Alternatively, the orchestrator 358 could determine the connection should be blocked based on the above rules and logic.

At any particular processing step or stage in the connection pathway in FIG. 3, the cumulative pathway information can allow the connection orchestrator 358 to determine if the connection pathway is at variance from the matching connection pathway model. This may occur even if the attempted connection includes all the authentication and/or authorization tokens required by that particular processing step.

FIG. 8D shows a table 870 with collected pathway information from the gateway and cloud desktop environments after the initial pathway information collected in the endpoint device environment 332. The table 870 includes the information previously collected from the table 860 and additional information for attributes corresponding to the gateway and cloud desktop stages in a column 872. In this example, when the gateway and desktop stages are reached, the cumulative information in the column 872 has not further diverged from the expected connection pathway for the example user using a WAN connection from a tablet based on a comparison with the connection model 840 in FIG. 8B. In this example, the connection orchestrator 358 may allow the connection based on the logic and rules.

Alternatively, as an example of a problematic attempt, if the pathway information were missing endpoint and gateway information, this would fail to have been mapped to a valid connection pathway model, or might be identified with an internal access connection pathway model that is associated with an internal attack by a network insider. FIG. 8E shows a table 880 that includes collected data in a column 882 from only the desktop stage. Data from the endpoint device stage such as the device OS, location, and IP address is missing. As this data should have collected by the monitor at the endpoint device stage, the connection analyzer 354 may block the connection.

The actions generated by the connection orchestrator 358 are received by the current processing supervisor (728). The actions may be determined based on a valid user and the comparison of the pathway model. If the user is not validated (718), the action is to disallow the connection.

Once actions are determined by the orchestrator 358, they are forwarded to the supervisor of the processing step such as the supervisors 362, 364, and 366 in FIG. 3. Actions are taken by the appropriate supervisor 362, 364, and 366, including the possibility of flagging the connection, and/or blocking the connection.

Thus, the current processing supervisor determines whether a flag has been set for the connection pathway (730). If a flag is set, the connection is flagged by the supervisor and reported back to the control plane 330 (732). Flagging a connection (732) may include actions such as requiring additional verification of credentials, issuing an alert based on the analysis to processing supervisors 362, 364, or 366, and automated pathway approval. The routine determines whether the connection should be blocked from the actions (734). If the action does not include blocking the connection, the connection is established (736). If the connection is to be blocked, the connection is then blocked by the supervisor (738).

There may be other options in the processing flow for a requested connection. For example, exceptional situations such as when no matching pathway is found may be included in the flow.

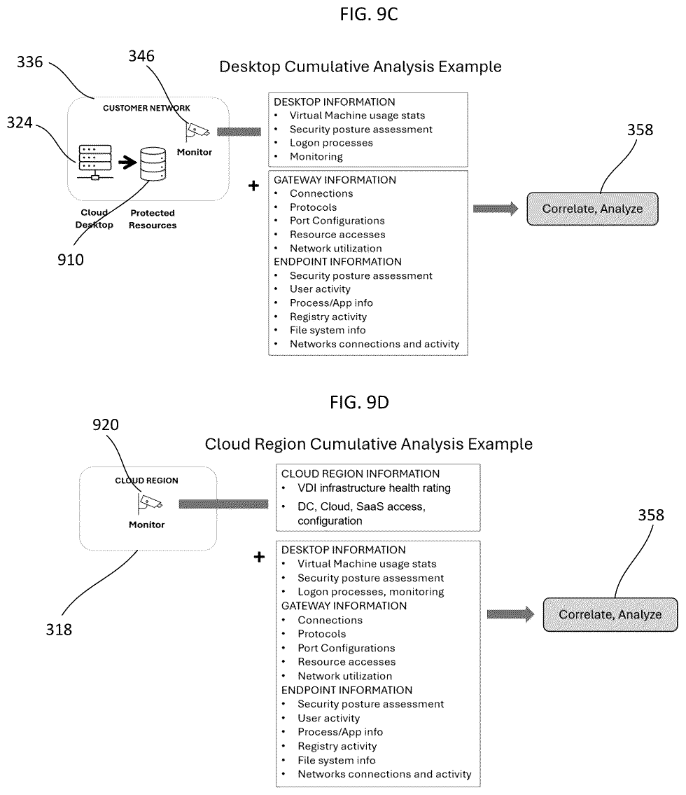

FIGS. 9A-9D summarize the kind of information that is potentially useful to be collected from the various processing steps at the endpoint environment, gateway environment, and Cloud desktop environments.

FIG. 9A shows the kind of information collected by the example monitor 342 from the endpoint device 314 at the endpoint device stage 332. This information may include geographical location, security posture assessment, user activity, process and application information, registry activity, file system information, and network connections and activity.

Software on the endpoint device 314 may immediately make use of this information on its own, even without analysis by the connection orchestrator 358 in the cloud desktop service control plane 330. For example, a posture check failure could block connection attempts immediately if the appropriate software in the endpoint device 314 is enabled. Even absent such software, the posture check information is forwarded to the control plane 330 for additional analysis and/or orchestration. The posture check information may be combined with other connection information and can be used later in the connection pathway. For example, a posture check indicating a slightly out-of-date operating system patch level may only be considered significant when combined with aggregated data from other processing steps in FIG. 7.

FIG. 9B shows information collected from a gateway such as the gateway appliance 322 by the gateway monitor 344 at the gateway stage 334. In this example, the collected information is cumulative including the information collected by the endpoint device monitor 342 in FIG. 9A. Additional information includes gateway information such as connections, protocols, port configurations, resource accesses, and network utilization.

FIG. 9C shows information collected from a Cloud desktop such as the cloud desktop 324 by the cloud desktop monitor 346 at the desktop monitor stage 336. In this example, the collected information is cumulative including the information collected by the endpoint device monitor 342 in FIG. 9A and the gateway monitor 344 in FIG. 9B. Additional information includes Cloud desktop information such as virtual machine usage statistics, security posture assessment, log on processes, and monitoring. An additional level of information may be collected by the cloud desktop 324 accessing resources 910 such as file storage servers and internal applications.

Finally, even the cloud region such as the Cloud region 318 itself can add infrastructural information or other context useful in analysis. FIG. 9D shows a Cloud region monitor 920 which includes data from a hypervisor and monitoring systems running in the cloud infrastructure. In this example, the Cloud region monitor 920 runs in the Cloud infrastructure at a the hypervisor level or may be a Cloud based monitoring tool such as Azure Sentinel or AWS Cloud Watch. The Cloud region monitor 920 may collect information that is cumulative including the information collected by the endpoint device monitor 342 in FIG. 9A, the gateway monitor 344 in FIG. 9B, and the Cloud desktop monitor 346 in FIG. 9C.

Additional features may be included in the example process flow to determine secure pathways. The policies and rules about creating and interpreting connection pathway models could include filtering to reduce the “noise” if there are too many invalid results. For example, some models could be considered to be duplicates if the connection pathways represented are similar enough or are considered low-risk variations.

The principles disclosed herein may be applied to extended pathways that have more than the three environments in FIG. 3. For example, there could be other component environment that the connection passes through that could also be monitored and supervised, such as firewall appliances, brokers, or proxies. Such additional environments would be provided with monitors that would communicate additional information to the desktop computing system control plane for incorporation into the connection models.

The example method may also include extended tracking of East/West attacks. Connection pathways could be extended to cover additional connections completely within the target network. For example, if users may or may not be authorized to connect to a target cloud desktop directly from other VMs, routine connections could be captured and modelled and analyzed at run-time just as in the remote connection cases described above. Anomalous connections would be flagged or blocked by the above described process. The only additional requirement is additional observers and supervisor components.

The concept of connection pathways could be extended to “resource pathways” in the virtual machine. Just as users have routine ways of connecting to a virtual machine, the resources that are accessed (such as a database) could become part of the pathway. Unusual resource accesses could be flagged or blocked by the same end-to-end analysis. Thus, the models could include resource accesses. This differs from other solutions available today because it is based on in-depth understanding of not only who the user is but how they arrived at the resource.

The concept of models of connection pathways could be extended to “action pathways.” Certain actions that users perform on the target cloud desktop (such as using encryption facilities to encrypt files) could be considered part of the pathway. Unusual actions could be flagged or blocked by the same end-to-end analysis by incorporating this data into the pathway connection model. This differs from other solutions available today because it is based on in-depth understanding of not only who the user is but how they arrived at the system that is used to invoke the action.

Security insights generated by the analysis performed by the connection analyzer 354 could be sanitized of sensitive information, aggregated, and shared across other users or customers using the regional datacenter to enhance security in the face of attacks that may have implications for multiple users. The information gathered by the connection analyzer 354 could also be part of a greater security ecosystem and incorporate observations and events from existing security toolsets mentioned above, including Extended Detection and Response (XDR), Security Information and Event Management (SIEM), Identity Providers (IdP)/Single Sign On (SSO) Solutions, Insider Risk Management (IRM), IT Service Management (ITSM), and others. The control plane may publish security insights to other components in a greater security ecosystem to be incorporated in action policies. Such action polices of a greater security ecosystem may include disabling credentials and locking or remotely wiping devices.

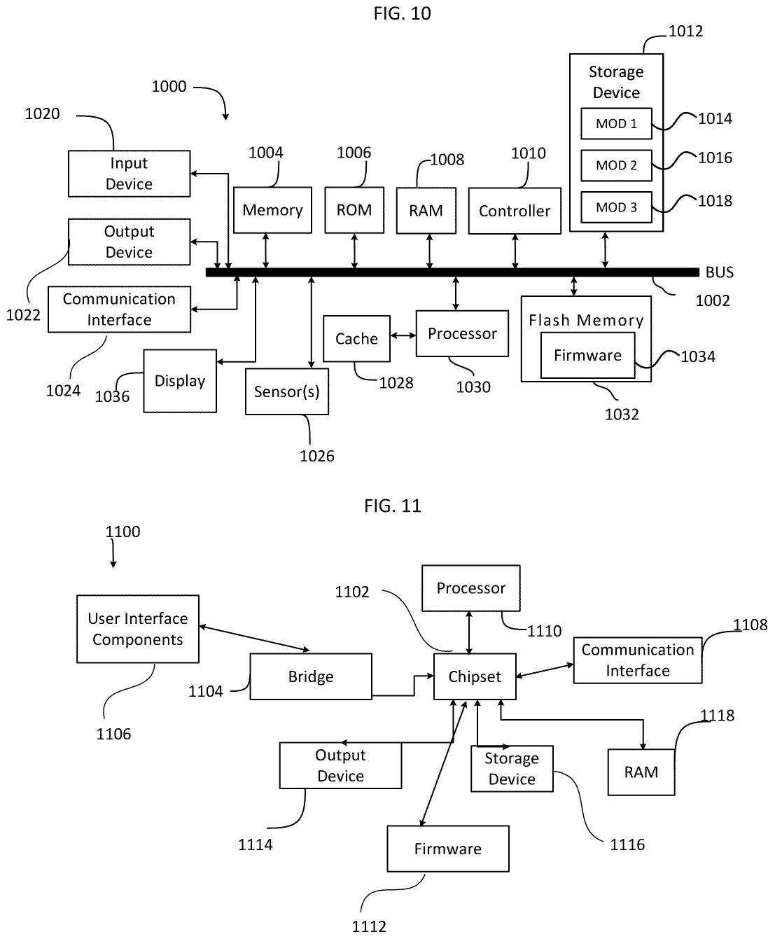

FIGS. 10-11 illustrate an example computing system 1000, in which the components of the computing system are in electrical communication with each other using a bus 1002. The system 1000 includes a processing unit (CPU or processor) 1030 and a system bus 1002 that couple various system components, including the system memory 1004 (e.g., read only memory (ROM) 1006 and random access memory (RAM) 1008), to the processor 1030. The system 1000 can include a cache of high-speed memory connected directly with, in close proximity to, or integrated as part of the processor 1030. The system 1000 can copy data from the memory 1004 and/or the storage device 1012 to the cache 1028 for quick access by the processor 1030. In this way, the cache can provide a performance boost for processor 1030 while waiting for data. These and other modules can control or be configured to control the processor 1030 to perform various actions. Other system memory 1004 may be available for use as well. The memory 1004 can include multiple different types of memory with different performance characteristics. The processor 1030 can include any general purpose processor and a hardware module or software module, such as module 1 1014, module 2 1016, and module 3 1018 embedded in storage device 1012. The hardware module or software module is configured to control the processor 1030, as well as a special-purpose processor where software instructions are incorporated into the actual processor design. The processor 1030 may essentially be a completely self-contained computing system that contains multiple cores or processors, a bus, memory controller, cache, etc. A multi-core processor may be symmetric or asymmetric.

To enable user interaction with the computing device 1000, an input device 1020 is provided as an input mechanism. The input device 1020 can comprise a microphone for speech, a touch-sensitive screen for gesture or graphical input, keyboard, mouse, motion input, and so forth. In some instances, multimodal systems can enable a user to provide multiple types of input to communicate with the system 1000. In this example, an output device 1022 is also provided. The communications interface 1324 can govern and manage the user input and system output.

Storage device 1012 can be a non-volatile memory to store data that is accessible by a computer. The storage device 1012 can be magnetic cassettes, flash memory cards, solid state memory devices, digital versatile disks, cartridges, random access memories (RAMs) 1008, read only memory (ROM) 1006, and hybrids thereof.

The controller 1010 can be a specialized microcontroller or processor on the system 1000, such as a BMC (baseboard management controller). In some cases, the controller 1010 can be part of an Intelligent Platform Management Interface (IPMI). Moreover, in some cases, the controller 1010 can be embedded on a motherboard or main circuit board of the system 1000. The controller 1010 can manage the interface between system management software and platform hardware. The controller 1010 can also communicate with various system devices and components (internal and/or external), such as controllers or peripheral components, as further described below.

The controller 1010 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 1010 to initiate or conduct specific hardware recovery procedures or operations, as further described below.

The controller 1010 can also include a system event log controller and/or storage for managing and maintaining events, alerts, and notifications received by the controller 1010. For example, the controller 1010 or a system event log controller can receive alerts or notifications from one or more devices and components, and maintain the alerts or notifications in a system event log storage component.

Flash memory 1032 can be an electronic non-volatile computer storage medium or chip that can be used by the system 1000 for storage and/or data transfer. The flash memory 1032 can be electrically erased and/or reprogrammed. Flash memory 1032 can include EPROM (erasable programmable read-only memory), EEPROM (electrically erasable programmable read-only memory), ROM, NVRAM, or CMOS (complementary metal-oxide semiconductor), for example. The flash memory 1032 can store the firmware 1034 executed by the system 1000 when the system 1000 is first powered on, along with a set of configurations specified for the firmware 1034. The flash memory 1032 can also store configurations used by the firmware 1034.

The firmware 1034 can include a Basic Input/Output System or equivalents, such as an EFI (Extensible Firmware Interface) or UEFI (Unified Extensible Firmware Interface). The firmware 1034 can be loaded and executed as a sequence program each time the system 1000 is started. The firmware 1034 can recognize, initialize, and test hardware present in the system 1000 based on the set of configurations. The firmware 1034 can perform a self-test, such as a POST (Power-On-Self-Test), on the system 1000. This self-test can test the functionality of various hardware components such as hard disk drives, optical reading devices, cooling devices, memory modules, expansion cards, and the like. The firmware 1034 can address and allocate an area in the memory 1004, ROM 1006, RAM 1008, and/or storage device 1012, to store an operating system (OS). The firmware 1034 can load a boot loader and/or OS, and give control of the system 1000 to the OS.

The firmware 1034 of the system 1000 can include a firmware configuration that defines how the firmware 1034 controls various hardware components in the system 1000. The firmware configuration can determine the order in which the various hardware components in the system 1000 are started. The firmware 1034 can provide an interface, such as an UEFI, that allows a variety of different parameters to be set, which can be different from parameters in a firmware default configuration. For example, a user (e.g., an administrator) can use the firmware 1034 to specify clock and bus speeds, define what peripherals are attached to the system 1000, set monitoring of health (e.g., fan speeds and CPU temperature limits), and/or provide a variety of other parameters that affect overall performance and power usage of the system 1000. While firmware 1034 is illustrated as being stored in the flash memory 1032, one of ordinary skill in the art will readily recognize that the firmware 1034 can be stored in other memory components, such as memory 1004 or ROM 1006.

System 1000 can include one or more sensors 1026. The one or more sensors 1026 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 1026 can communicate with the processor, cache 1028, flash memory 1032, communications interface 1024, memory 1004, ROM 1006, RAM 1008, controller 1010, and storage device 1012, via the bus 1002, for example. The one or more sensors 1026 can also communicate with other components in the system via one or more different means, such as inter-integrated circuit (I2C), general purpose output (GPO), and the like. Different types of sensors (e.g., sensors 1026) on the system 1000 can also report to the controller 1010 on parameters, such as cooling fan speeds, power status, operating system (OS) status, hardware status, and so forth. A display 1036 may be used by the system 1000 to provide graphics related to the applications that are executed by the controller 1010.

FIG. 11 illustrates an example computer system 1100 having a chipset architecture that can be used in executing the described method(s) or operations, and generating and displaying a graphical user interface (GUI). Computer system 1100 can include computer hardware, software, and firmware that can be used to implement the disclosed technology. System 1100 can include a processor 1110, representative of a variety of physically and/or logically distinct resources capable of executing software, firmware, and hardware configured to perform identified computations. Processor 1110 can communicate with a chipset 1102 that can control input to and output from processor 1110. In this example, chipset 1102 outputs information to output device 1114, such as a display, and can read and write information to storage device 1116. The storage device 1116 can include magnetic media, and solid state media, for example. Chipset 1102 can also read data from and write data to RAM 1118. A bridge 1104 for interfacing with a variety of user interface components 1106, can be provided for interfacing with chipset 1102. User interface components 1106 can include a keyboard, a microphone, touch detection, and processing circuitry, and a pointing device, such as a mouse.

Chipset 1102 can also interface with one or more communication interfaces 1108 that can have different physical interfaces. Such communication interfaces can include interfaces for wired and wireless local area networks, for broadband wireless networks, and for personal arca networks. Further, the machine can receive inputs from a user via user interface components 1106, and execute appropriate functions, such as browsing functions by interpreting these inputs using processor 1110.

Moreover, chipset 1102 can also communicate with firmware 1112, which can be executed by the computer system 1100 when powering on. The firmware 1112 can recognize, initialize, and test hardware present in the computer system 1100 based on a set of firmware configurations. The firmware 1112 can perform a self-test, such as a POST, on the system 1100. The self-test can test the functionality of the various hardware components 1102-1118. The firmware 1112 can address and allocate an area in the memory 1118 to store an OS. The firmware 1112 can load a boot loader and/or OS, and give control of the system 1100 to the OS. In some cases, the firmware 1112 can communicate with the hardware components 1102-1110 and 1114-1118. Here, the firmware 1112 can communicate with the hardware components 1102-1110 and 1114-1118 through the chipset 1102, and/or through one or more other components. In some cases, the firmware 1112 can communicate directly with the hardware components 1102-1110 and 1114-1118.

It can be appreciated that example systems 1000 (in FIGS. 10) and 1100 can have more than one processor (e.g., 1030, 1110), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A system providing a secure pathway between an endpoint device and a virtual desktop executed by one or more servers, the system comprising:
a client monitor that receives connection information from an endpoint device operated by a user during an endpoint device stage of a connection pathway;
a gateway monitor receiving connection information from a gateway accessible by the endpoint device during a gateway stage of the connection pathway;
a virtual desktop monitor receiving connection information from the virtual desktop during a desktop stage of the connection pathway;
a real-time connection database storing the connection information from the client monitoring interface, gateway monitor and virtual desktop monitor;
a models database storing a connection pathway model with connection information from previous connections made by an endpoint device operated by the user; and
a connection orchestrator that compares the connection pathway model with the connection information received by at least one of the client monitor, the gateway monitor, or the virtual desktop monitor and determines whether to block the connection based on the comparison.

2. The system of claim 1, wherein the models database includes a plurality of connection pathway models, each associated with the user, and wherein the connection orchestrator compares all of the connection pathway models with the connection information.

3. The system of claim 1, further comprising:
a client connection supervisor coupled to the endpoint device;
a gateway connection supervisor coupled to the gateway;
a desktop connection supervisor coupled to the virtual desktop; and
a control plane coupled to the client connection supervisor, gateway connection supervisor and desktop connection supervisor, the control plane including the connection analyzer, the control plane operable to control one of the client connection supervisor, gateway connection supervisor and desktop connection supervisor to block the connection.

4. The system of claim 1, wherein the connection orchestrator is operable to flag the connection based on the comparison.

5. The system of claim 1, wherein the connection orchestrator is operable to perform the comparison at each of the stages of the connection pathway.

6. The system of claim 1, further comprising a connection analyzer that accesses a model template to create the connection pathway model with the connection information from previous connections made by an endpoint device operated by the user.

7. The system of claim 1, further comprising another monitor and another supervisor, wherein the connection pathway includes another stage, wherein the another monitor collects information from the another stage, and the another supervisor blocks connection at the another stage.

8. The system of claim 1, wherein the connection information collected by the endpoint device monitor includes at least one of device operating system, device location, network type, IP address, gateway, a unique device identifier, and a unique network identifier.

9. The system of claim 1, wherein the connection information collected by the gateway monitor includes at least one of a gateway name, a gateway protocol, ports use, network tracking, a network latency, and an authentication method.

10. The system of claim 1, wherein the connection information collected by the Cloud desktop monitor includes at least one of a name of the gateway, a regional data center, and a network ID.

11. A method for providing a secure pathway for connecting an endpoint device to a virtual desktop via a gateway and Cloud based region, the method comprising:
receiving connection information from an endpoint device operated by a user during an endpoint device stage of a connection pathway;
receiving connection information from a gateway accessible by the endpoint device during a gateway stage of the connection pathway;
receiving connection information from the virtual desktop during a desktop stage of the connection pathway;
storing the connection information from the client monitoring interface, gateway monitor and virtual desktop monitor in a real-time connection database;
comparing a connection pathway model with connection information from previous connections made by an endpoint device operated by the user with the connection information; and
determining whether to block the connection based on the comparison.

12. The method of claim 11, wherein the connection pathway model is one of a plurality of connection pathway models, each associated with the user, and wherein the method further comprises comparing all of the connection pathway models with the connection information.

13. The method of claim 11, wherein a client connection supervisor is coupled to the endpoint device; a gateway connection supervisor is coupled to the gateway; and a desktop connection supervisor coupled to the virtual desktop; and wherein a control plane is coupled to the client connection supervisor, gateway connection supervisor and desktop connection supervisor, the control plane operable to control one of the client connection supervisor, gateway connection supervisor and desktop connection supervisor to block the connection.

14. The method of claim 11, further comprising flagging the connection based on the comparison.

15. The method of claim 11, wherein the comparison is performed at each of the stages of the connection pathway.

16. The method of claim 11, further comprising accessing a model template to create the connection pathway model with the connection information from previous connections made by an endpoint device operated by the user.

17. The method of claim 11, further comprising collecting information from another stage of the connection pathway, and wherein a supervisor blocks connection at the another stage based on the comparison.

18. The method of claim 11, wherein the connection information received by the endpoint device includes at least one of device operating system, device location, network type, IP address, gateway, a unique device identifier, and a unique network identifier.

19. The method of claim 11, wherein the connection information received by the gateway includes at least one of a gateway name, a gateway protocol, ports use, network tracking, a network latency, and an authentication method.

20. The method of claim 11, wherein the connection information received by the Cloud desktop includes at least one of a name of the gateway, a regional data center, and a network ID.

21. A non-transitory computer-readable medium having machine-readable instructions stored thereon, which when executed by a processor, cause the processor to:
receive connection information from an endpoint device operated by a user during an endpoint device stage of a connection pathway;
receive connection information from a gateway accessible by the endpoint device during a gateway stage of the connection pathway;
receive connection information from the virtual desktop during a desktop stage of the connection pathway;
store the connection information from the client monitoring interface, gateway monitor and virtual desktop monitor in a real-time connection database;
compare a connection pathway model with connection information from previous connections made by an endpoint device operated by the user with the connection information; and
determine whether to block the connection based on the comparison.
